(19) United States
(12) Patent Application Publication
(10) Pub. No.: US 2019/0355352 A1
(43) Pub. Date: Nov. 21, 2019

(54) VOICE AND CONVERSATION RECOGNITION SYSTEM

(71) Applicant: Honda Motor Co., Ltd., Tokyo (JP)

(72) Inventors: Adrian Peters Kane, Sunnyvale, CA (US); Robert Wesley Murrish, Santa Clara, CA (US); Shuhei Kinoshita, Sunnyvale, CA (US); Wonravee Chavalit, San Jose, CA (US)

(21) Appl. No.: 15/983,523

(22) Filed: May 18, 2018

(51) Int. Cl. G10L 15/22; G06K 9/00; G10L 15/18; G10L 17/00; G10L 17/06

(52) U.S. Cl. CPC G10L 15/22; G06K 9/00288; G10L 15/1815; G10L 2015/088; G10L 17/06; G06K 9/00832; G10L 17/005

(57) ABSTRACT

A conversation recognition system on board a vehicle includes an acoustic sensor component that detects sound in a cabin of the vehicle, a voice recognition component coupled to the acoustic sensor component that analyzes the sound detected by the acoustic sensor component and identifies a plurality of utterances, and a conversation threading unit coupled to the voice recognition component that analyzes the utterances identified by the voice recognition component and identifies a plurality of conversations between a plurality of occupants of the vehicle. The conversation recognition system enables multiple conversations in an environment to be recognized and distinguished from each other.

### BACKGROUND

Companies have used a wide range of technologies in an effort to improve their products and/or customer service. Communication technologies, for example, have provided platforms and/or channels that facilitate a variety of customer experiences, allowing companies to better manage customer relations. Some known communication technologies include microphone-based systems that allow products to have improved features, such as voice-based input interfaces. These microphone-based systems also allow companies to collect customer data to gain insights (e.g., for targeted marketing). Some known microphone-based systems, such as automatic speech recognition (ASR), are able to separate voice from noise, and then translate the voice to text. However, known ASR systems are limited in their ability to understand context and extract meaning from the words and sentences. Moreover, known ASR systems presume a set number of speakers and/or conversations, or ignore how many speakers and/or conversations there are altogether.

### SUMMARY

Examples of the disclosure enable multiple conversations in an environment to be recognized and distinguished from each other. In one aspect, a conversation recognition system is provided on board a vehicle. The conversation recognition system includes an acoustic sensor component configured to detect sound in a cabin of the vehicle, a voice recognition component coupled to the acoustic sensor component that is configured to analyze the sound detected by the acoustic sensor component and identify a plurality of utterances, and a conversation threading unit coupled to the voice recognition component that is configured to analyze the utterances identified by the voice recognition component and identify a plurality of conversations between a plurality of occupants of the vehicle.

In another aspect, a method is provided for recognizing conversation in a cabin of a vehicle. The method includes detecting a plurality of sounds in the cabin of the vehicle, analyzing the sounds to identify a plurality of utterances expressed in the cabin of the vehicle, grouping the utterances into one or more conversation threads based on content of the utterances and one or more content-agnostic factors, and analyzing the conversation threads to identify a plurality of conversations between a plurality of occupants of the vehicle. The content-agnostic factors include a speaker identity, a speaker location, a listener identity, a listener location, and an utterance time.

In yet another aspect, a computing system is provided for use in recognizing conversation in a cabin of a vehicle. The computing system includes one or more computer storage media including data associated with one or more vehicles and computer-executable instructions, and one or more processors. The processors execute the computer-executable instructions to identify a plurality of sounds in the cabin of a first vehicle of the vehicles, analyze the sounds to identify a plurality of utterances expressed in the cabin of the first vehicle, group the utterances to form a plurality of conversation threads based on content and one or more content-agnostic factors, and group the conversation threads to form a plurality of conversations between a plurality of occupants of the first vehicle. The content-agnostic factors include a speaker identity, a speaker location, a listener identity, a listener location, and an utterance time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 includes a schematic plan view of an example vehicle including a cabin accommodating a plurality of occupants.

FIG. 2 includes a block diagram of an example conversation recognition system that may be used to identify a plurality of conversations between a plurality of speakers, such as the occupants shown in FIG. 1.

FIG. 3 includes a block diagram of an example linguistic system that may be used with a conversation recognition system, such as the conversation recognition system shown in FIG. 2.

FIG. 4 includes a schematic diagram of an example set of utterances detected in an environment, such as the cabin shown in FIG. 1.

FIG. 5 includes a schematic plan view of the vehicle shown in FIG. 1 in a state of conversation.

FIG. 6 includes a flowchart of an example method of using a system, such as the conversation recognition system shown in FIG. 2, to recognize a plurality of conversations between a plurality of speakers, such as the occupants shown in FIG.

1.

FIG. 7 includes a schematic diagram of various stages of recognizing a plurality of conversations using the method shown in FIG. 6.

FIG. 8 includes a block diagram of an example cloud-based environment for recognizing a plurality of conversations using a system, such as the conversation recognition system shown in FIG. 2.

FIG. 9 includes a block diagram of an example computing system that may be used to recognize a plurality of conversations using a system, such as the conversation recognition system shown in FIG. 2.

Corresponding reference characters indicate corresponding parts throughout the drawings. Although specific features may be shown in some of the drawings and not in others, this is for convenience only. In accordance with the examples described herein, any feature of a drawing may be referenced and/or claimed in combination with any feature of any other drawing.

### DETAILED DESCRIPTION

The present disclosure relates to communication systems and, more particularly, to systems and methods for recognizing voice and conversation within a cabin of a vehicle. Examples described herein include a conversation recognition system on board the vehicle that detects sound in the cabin of the vehicle, and analyzes the sound to identify a plurality of utterances expressed in the cabin of the vehicle. The utterances are grouped based on the content of the utterances and one or more contextual or prosodic factors to form a plurality of conversations. The context and prosody of the utterances and/or conversations provide added meaning to the content, allowing a conversation to be distinguished from noise and other conversations. While the examples described herein are described with respect to recognizing voice and conversation within a cabin of a vehicle, one of ordinary skill in the art would understand and appreciate that the example systems and methods may be used to recognize voice and conversation as described herein in any environment.

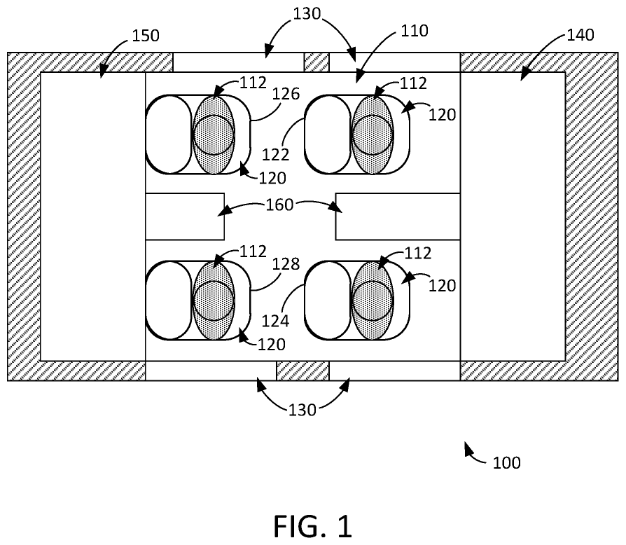

FIG. 1 shows an example vehicle 100 including a passenger compartment or cabin 110. The cabin 110 is configured to accommodate one or more occupants 112. For example, the cabin 110 may include a plurality of seats 120. In some examples, the seats 120 include a left-front seat 122, a right-front seat 124, a left-rear seat 126, and a right-rear seat 128. While the cabin 110 is described and shown to include four seats 120, one of ordinary skill in the art would understand and appreciate that the cabin 110 described herein may include any quantity of seats in various arrangements.

The vehicle 100 includes one or more doors 130 that allow the occupants 112 to enter into and leave from the cabin 110. In the cabin 110, one or more occupants 112 may have access to a dashboard 140 towards a front of the cabin 110, a rear deck 150 towards a rear of the cabin 110, and/or one or more consoles 160 between the dashboard 140 and rear deck 150. In some examples, the vehicle 100 includes one or more user interfaces and/or instrumentation (not shown) in the seats 120, doors 130, dashboard 140, rear deck 150, and/or consoles 160. The occupants 112 may access and use the user interfaces and/or instrumentation, for example, to operate the vehicle 100 and/or one or more components of the vehicle 100.

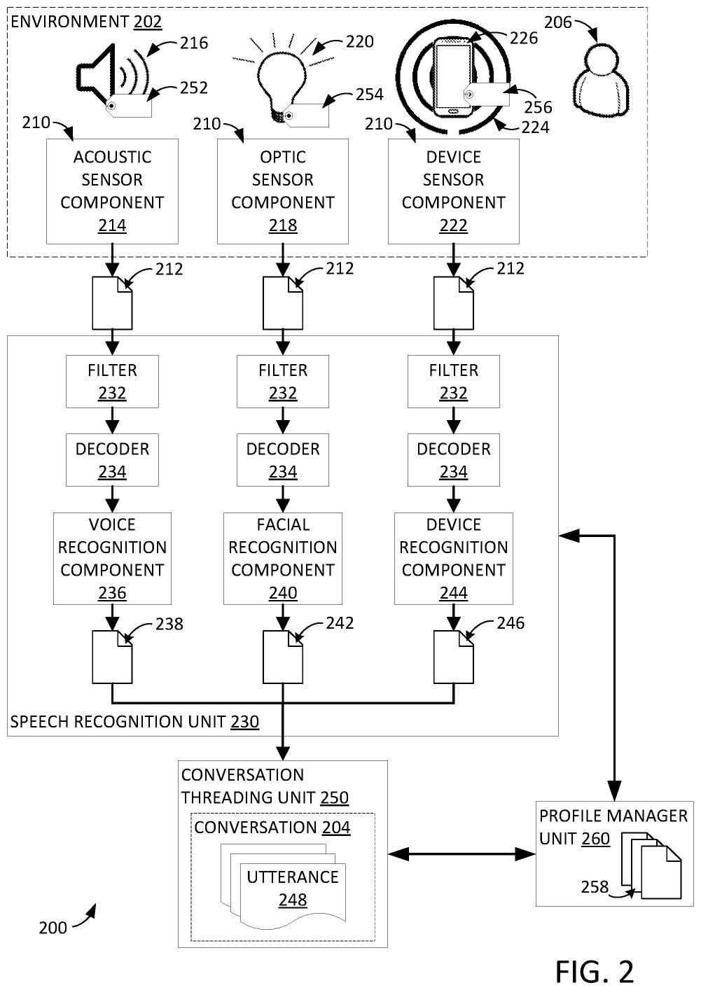

FIG. 2 shows an example conversation recognition system 200 that may be used to monitor an environment 202 (e.g., cabin 110). The conversation recognition system 200 may be used, for example, to identify one or more conversations 204 between a plurality of users 206 in the environment 202, such as the occupants 112 (shown in FIG. 1). While the conversation recognition system 200 is described and shown to monitor the cabin 110 for one or more conversations 204, one of ordinary skill in the art would understand and appreciate that the conversation recognition system 200 may be used to monitor a wide range of environments for various stimuli, features, and/or parameters.

The conversation recognition system 200 includes one or more sensor units 210 configured to detect one or more stimuli, and generate data or one or more signals 212 associated with the stimuli. Example sensor units 210 include, without limitation, a microphone, an electrostatic sensor, a piezoelectric sensor, a camera, an image sensor, a photoelectric sensor, an infrared sensor, an ultrasonic sensor, a microwave sensor, a magnetometer, a motion sensor, a receiver, a transceiver, and any other device configured to detect a stimulus in the environment 202. In some examples, the sensor units 210 include an acoustic sensor component 214 that detects sound 216 (e.g., acoustic waves), an optic sensor component 218 that detects light 220 (e.g., electromagnetic waves), and/or a device sensor component 222 that detects wireless or device signals 224 (e.g., radio waves, electromagnetic waves) transmitted by one or more user devices 226.

The user devices 226 may transmit the device signals 224 using one or more communication protocols. Example communication protocols include, without limitation, a BLUETOOTH® brand communication protocol, a ZIGBEE® brand communication protocol, a Z-WAVE™ brand communication protocol, a WI-FI® brand communication protocol, a near field communication (NFC) communication protocol, a radio frequency identification (RFID) communication protocol, and a cellular data communication protocol (BLUETOOTH® is a registered trademark of Bluetooth Special Interest Group ZIGBEE® is a registered trademark of ZigBee Alliance Corporation, and Z-WAVE™ is a trademark of Sigma Designs, Inc. WI-FI® is a registered trademark of the Wi-Fi Alliance.).

The sensor units 210 may transmit or provide the signals 212 to a speech recognition unit 230 in the conversation recognition system 200 for processing. In some examples, the speech recognition unit 230 includes one or more filters 232 that remove at least some undesired portions (“noise”) from the signals 212, and/or one or more decoders 234 that convert one or more signals 212 into one or more other forms. A decoder 234 may convert an analog signal, for example, into a digital form.

The speech recognition unit 230 is configured to analyze the signals 212 received or retrieved from the sensor units 210 to recognize or identify one or more features associated with the stimuli detected by the sensor units 210 (e.g., sound 216, light 220, device signals 224). For example, the speech recognition unit 230 may include a voice recognition component 236 that analyzes one or more signals 212 received or retrieved from the acoustic sensor component 214 (e.g., audio signals) to identify one or more auditory features 238 of the detected sound 216, a facial recognition component 240 that analyzes one or more signals 212 received or retrieved from the optic sensor component 218 (e.g., image signals, video signals) to identify one or more visual features 242 of the detected light 220, and/or a device recognition component 244 that analyzes one or more signals 212 received or retrieved from the device sensor component 222 (e.g., wireless signals) to identify one or more device features 246 of one or more user devices 226 associated with the detected device signals 224. In some examples, the speech recognition unit 230 analyzes the auditory features 238, visual features 242, and/or device features 246 to recognize or identify one or more units of speech or utterances 248 (e.g., words, phrases, sentences, paragraphs) expressed in the environment 202. The speech recognition unit 230 may perform, for example, one or more speaker diarization-related operations such that each utterance 248 is speaker-homogeneous (e.g., each utterance 248 is expressed by a single speaker).

The speech recognition unit 230 may transmit or provide the utterances 248 and/or features (e.g., auditory features 238, visual features 242, device features 246) to a conversation threading unit 250 in the conversation recognition system 200 for processing. The conversation threading unit 250 is configured to analyze the utterances 248 and/or features to cluster or group the utterances 248, forming one or more conversations 204. The utterances 248 may be grouped, for example, based on one or more commonalities or compatibilities among the utterances 248. In some examples, the conversation threading unit 250 separates one or more utterances 248 from one or more other utterances 248 based on one or more differences or incompatibilities between the utterances 248.

In some examples, the conversation recognition system 200 recognizes or identifies one or more non-linguistic aspects of the environment 202. For example, the speech recognition unit 230 may analyze the auditory features 238, visual features 242, and/or device features 246 to identify one or more voiceprints 252, faceprints 254, and/or device identifiers 256, respectively. Voiceprints 252, faceprints 254, and device identifiers 256 each include one or more objective, quantifiable characteristics that may be used to uniquely identify one or more users 206 in the environment 202. Example voiceprints 252 include, without limitation, a spectrum of frequencies and amplitudes of sound 216 over time. Example faceprints 254 include, without limitation, a distance between eyes, an eye socket depth, a nose length or width, a cheekbone shape, and a jaw line length. Example device identifiers 256 include, without limitation, a friendly name, a domain-based identifier, a universally unique identifier (UUID), a unique device identifier (UDID), a media access control (MAC) address, a mobile equipment identifier (MEID), an electronic serial number (ESN), an integrated circuit card identifier (ICCID), an international mobile equipment identity (IMEI) number, an international mobile subscriber identity (IMSI) number, a serial number, a BLUETOOTH® brand address, and an Internet Protocol (IP) address.

In some examples, the speech recognition unit 230 compares the voiceprints 252, faceprints 254, and/or device identifiers 256 with profile data 258 including one or more familiar voiceprints 252, faceprints 254, and/or device identifiers 256 to find a potential match that would allow one or more users 206 in the environment 202 to be uniquely identified. The conversation recognition system 200 may include, for example, a profile manager unit 260 that maintains profile data 258 associated with one or more users 206. The profile manager unit 260 enables the conversation recognition system 200 to recognize or identify a user 206 and/or one or more links or relations between the user 206 and one or more other users 206, vehicles 100, and/or devices (e.g., user device 226) in a later encounter with increased speed, efficiency, accuracy, and/or confidence. Example user profile data 258 includes, without limitation, a user identifier, biometric data (e.g., voiceprint 252, faceprint 254), a vehicle identification number (VIN), a device identifier 256, user preference data, calendar data, message data, and/or activity history data.

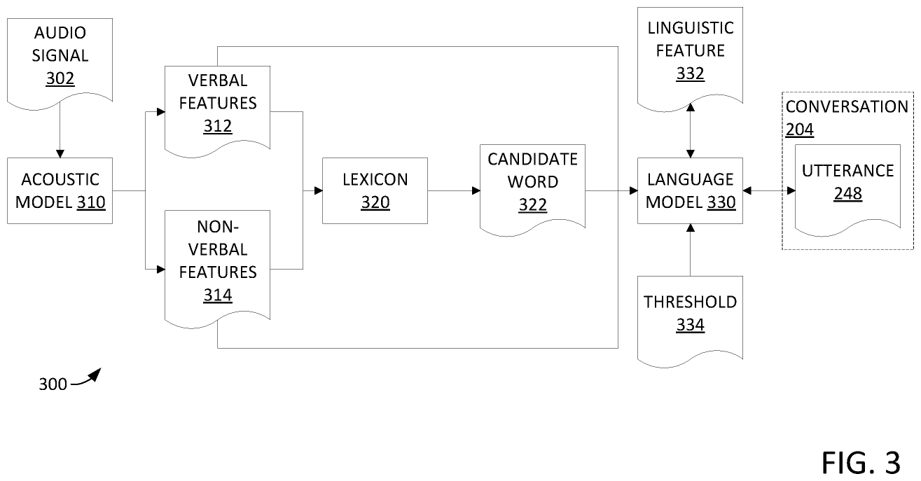

FIG. 3 shows an example linguistic system 300 that may be used to extract one or more meanings from one or more communications (e.g., conversation 204, utterance 248). The linguistic system 300 may include, be included in, or be coupled to the speech recognition unit 230 (shown in FIG. 2) and/or conversation threading unit 250 (shown in FIG. 2), for example, to identify one or more conversations 204 and/or utterances 248.

In some example, the linguistic system 300 identifies a plurality of conversations 204 by processing one or more audio signals 302 (e.g., signal 212) associated with vocal speech. The audio signals 302 may be received or retrieved, for example, from one or more sensor units 210 (shown in FIG. 2), user devices 226 (shown in FIG. 2), filters 232 (shown in FIG. 2), and/or decoders 234 (shown in FIG. 2). While the linguistic system 300 is described and shown to analyze and interpret vocal speech, one of ordinary skill in the art would understand and appreciate that the linguistic system 300 described herein may be used to analyze and interpret any distinct sound 216 or gesture that is characteristic of a language.

The linguistic system 300 includes an acoustic model 310 that analyzes the audio signals 302 to identify one or more verbal features 312. Verbal features 312 include one or more sounds 216 or gestures that are characteristic of a language and, thus, may be conveyed or expressed by a person (e.g., user 206) to communicate information and/or meaning. The acoustic model 310 may identify one or more auditory aspects of verbal features 312 (e.g., auditory features 238), for example, by analyzing content, such as phonetic sounds 216 (e.g., vowels, consonants, syllables), as well as sound qualities of the content. Example auditory aspects of verbal features 312 include, without limitation, phonemes, formants, lengths, rhythm, tempo, cadence, volumes, timbres, voice qualities, articulations, pronunciations, stresses, tones, tonicities, tonalities, intonations, and pitches. In some examples, the acoustic model 310 analyzes one or more signals other than audio signals 302 (e.g., image signals, video signals, wireless signals) to identify one or more physical (e.g., visual) aspects of verbal features 312 that confirm the auditory aspects. A shape or movement of the mouth or lips, for example, may be indicative of a phonetic sound 216 and/or sound quality.

In some examples, the acoustic model 310 analyzes the audio signals 302 to identify or confirm one or more nonverbal features 314. Nonverbal features 314 include any sound 216 or gesture, other than verbal features 312, that communicates information and/or meaning. Sound qualities, such as a volume and/or a temporal difference in the detection of sound 216, may be indicative of a distance and/or a direction from a source of a sound 216. Additionally, the acoustic model 310 may analyze one or more signals other than audio signals 302 (e.g., image signals, video signals, wireless signals) to identify or confirm one or more nonverbal features 314. Example nonverbal features 314 include, without limitation, gasps, sighs, whistles, throat clears, coughs, tongue clicks, mumbles, laughter, facial expressions, eye position or movement, body posture or movement, touches, spatial gaps, and temporal gaps.

Some nonverbal features 314 may support, reinforce, and/or be emblematic of speech (e.g., verbal features 312). Examples of these types of non-verbal features 314 include, without limitation, a hand wave for “hello,” a head nod for “yes,” a head shake for “no,” a shoulder shrug for “don't know,” and a thumbs-up gesture for “good job.” Moreover, some nonverbal features 314 may express understanding, agreement, or disagreement; define roles or manage interpersonal relations; and/or influence turn taking. Examples of these types of nonverbal features 314 include, without limitation, a head nod or shake, an eyebrow raise or furrow, a gaze, a finger raise, and a nonverbal sound 216 (e.g., gasps, sighs, whistles, throat clears, coughs, tongue clicks, mumbles, laughter). Furthermore, some nonverbal features 314 may reflect an emotional state. Examples of these types of nonverbal features 314 include, without limitation, a facial expression, an eye position or movement, a body posture or movement, a touch, a spatial gap, and a temporal gap.

In some examples, the linguistic system 300 includes a pronunciation dictionary or lexicon 320 that analyzes one or more verbal features 312 and/or nonverbal features 314 to identify one or more candidate words 322, and/or a language model 330 that analyzes the verbal features 312, nonverbal features 314, and/or one or more combinations of candidate words 322 to identify one or more linguistic features 332. In addition to a literal meaning of the candidate words 322, the linguistic features 332 may recognize or identify syntactic, semantic, and/or prosodic context, such as a usage (e.g., statement, command, question), an emphasis or focus, a presence of irony or sarcasm, an emotional state, and/or other aspects less apparent in, absent from, or contrary to the literal meaning of the candidate words 322. In some examples, the language model 330 compares the combinations of candidate words 322 and the corresponding linguistic features 332 with one or more predetermined thresholds 334 to identify a comprehensible string of words that satisfies the predetermined thresholds 334 (e.g., utterance 248). Example predetermined thresholds 334 include, without limitation, a syntactic rule, a semantic rule, and a prosodic rule.

The language model 330 is configured cluster or group one or more utterances 248 based on one or more linguistic features 332. In some examples, the language model 330 analyzes one or more combinations of utterances 248 and the corresponding linguistic features 332 to identify a comprehensible string of utterances 248 (e.g., conversations 204). The combinations of utterances 248 and the corresponding linguistic features 332 may be compared, for example, with the predetermined thresholds 334 to identify a combination of utterances 248 that satisfies the predetermined thresholds 334 (e.g., the comprehensible string of utterances 248).

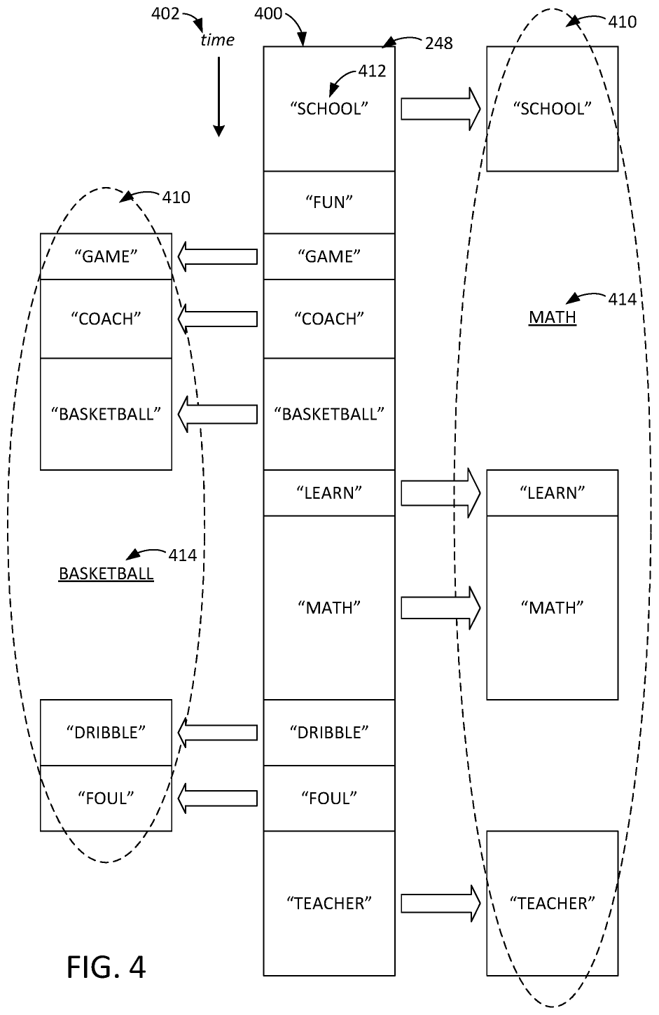

FIG. 4 shows an example utterance set 400 including a plurality of utterances 248 detected in an environment 202 (e.g., cabin 110) over a period of time 402. The utterances 248 may be identified using, for example, the speech recognition unit 230 (shown in FIG. 2) and/or language model 330 (shown in FIG. 3).

Content may be used to group the utterances 248 into one or more conversation threads 410. An utterance 248 may include, for example, one or more keywords 412 that are indicative of one or more semantic fields or topics 414 associated with the utterance 248. For example, as shown in FIG. 4, an utterance 248 including a keyword 412 of “school” may be grouped with one or more other utterances 248 including the same keyword 412 and/or another keyword 412 that is indicative of a common topic 414 (e.g., math). Additionally or alternatively, the utterance 248 including the keyword 412 of “school” may be separated from one or more other utterances 248 including a keyword 412 that is indicative of a disparate topic 414 (e.g., basketball).

The conversation recognition system 200 is configured to analyze one or more utterances 248 to identify one or more keywords 412, and group the utterances 248 based on one or more topics 414 corresponding to the identified keywords 412. As shown in FIG. 4, utterances 248 including keywords 412 of “game,” “coach,” “basketball,” “dribble,” and “foul” may be grouped together in a basketball-related topic 414, and utterances 248 including keywords 412 of “school,” “learn,” “math,” and “teacher” may be grouped together in a math-related topic 414. An utterance 248 including an indiscriminate keyword 412 (e.g., “fun”) may be grouped with or separated from one or more utterances 248 based on one or more linguistic features 332 other than topic 414.

An utterance 248 may also include one or more discourse markers that facilitate organizing a conversation thread 410. A series of utterances 248 including ordinal numbers (e.g., “first,” “second,” etc.), for example, may be grouped in accordance with the ordinal numbers. Utterances 248 including adjacency pairs, for another example, may also be grouped together. Adjacency pairs include an initiating utterance 248 and a responding utterance 248 corresponding to the initiating utterance 248. Example adjacency pairs include, without limitation, information and acknowledgement, a question and answer, a prompt and response, a call and beckon, an offer and acceptance or rejection, a compliment and acceptance or refusal, and a complaint and remedy or excuse.

The conversation recognition system 200 is configured to analyze one or more utterances 248 to identify one or more discourse markers, and group the utterances 248 in accordance with the discourse markers. In some examples, the conversation recognition system 200 groups a plurality of adjacency pairs together. The adjacency pairs may include, for example, a linking utterance 248 that is a responding utterance 248 in one adjacency pair (e.g., a first adjacency pair) and an initiating utterance 248 in another adjacency pair (e.g., a second adjacency pair).

Content-agnostic linguistic features 332 may also be used to group the utterances 248 into one or more conversation threads 410. Content-agnostic linguistic features 332 may include, for example, an utterance time, an utterance or speaker location, an utterance direction, a speaker identity, and/or a listener identity. To group utterances 248 based on one or more times, locations, and/or directions associated with the utterances 248, the conversation recognition system 200 may compare the utterances times, locations, and/or directions with each other to identify one or more differences in the utterance times, locations, and/or directions, and compare the differences with one or more predetermined thresholds 334 to determine one or more likelihoods of the utterances 248 being in a common conversation 204. The utterances 248 may then be grouped together or separated from each other based on the determined likelihoods.

Utterances 248 expressed closer in time (e.g., with a smaller temporal gap), for example, may be more likely to be grouped together than utterances 248 expressed farther apart in time (e.g., with a larger temporal gap). However, concurrent utterances 248 are less likely to be grouped together than successive utterances 248. In this manner, utterances 248 expressed concurrently (e.g., the difference is equal to zero or is less than a predetermined amount of time) or with a temporal gap that exceeds a predetermined amount of time may not be grouped together into a common conversation thread 410.

Utterances 248 expressed toward each other, for another example, may be more likely to be grouped together than utterances 248 expressed away from each other. Moreover, utterances 248 expressed closer in space (e.g., with a smaller spatial gap) are more likely to be grouped together than utterances 248 expressed farther apart in space (e.g., with a larger spatial gap). In this manner, utterances 248 expressed with a spatial gap that exceeds a predetermined distance may not be grouped together into a common conversation thread 410.

The utterances 248 may also be grouped based on a role or identity of one or more people associated with the utterances 248 (e.g., user 206). In some examples, the conversation recognition system 200 analyzes one or more utterances 248 to identify one or more users 206 and/or one or more roles associated with the users 206, and groups the utterances 248 based at least in part on their identities and/or roles. Utterances 248 expressed by users 206 exhibiting complementary roles over a period of time (e.g., alternating between speaker 508 and intended listener 510), for example, may be grouped together. In some examples, the conversation recognition system 200 identifies the users 206 and/or roles based on one or more linguistic features 332 and/or predetermined thresholds 334. Utterances 248 between a parent and a child, for example, may include simpler words and/or grammar, involve more supportive communication (e.g., recasting, language expansion), and/or be spoken more slowly, at higher pitches, and/or with more pauses than utterances 248 between a plurality of adults.

Additionally or alternatively, profile data 258 may be used to identify at least some users 206 and/or their roles. A user 206 may be identified, for example, based on a user identifier, biometric data (e.g., voiceprint 252, faceprint 254), a device identifier 256 of a user device 226 associated with the user 206, a VIN of a vehicle 100 associated with the user, a user preference of a particular seat within a vehicle 100 (e.g., the driver's seat), and/or a schedule indicative or predictive of the user 206 being in the environment 200 (e.g., travel time). Profile data 258 may provide one or more other contextual clues for grouping one or more utterances 248. For example, a user 206 may have an activity history of talking about work on weekdays, during business hours, and/or with one set of other users 206, and about leisure on nights and weekends with another set of other users 206.

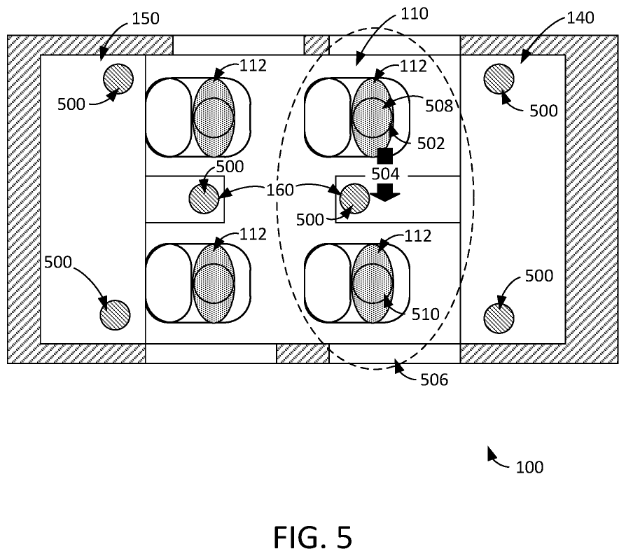

FIG. 5 shows a plurality of microphones 500 (e.g., acoustic sensor component 214) that may be used to detect sound 216 (shown in FIG. 2) or a presence of one or more occupants 112 (e.g., users 206) in the cabin 110 of the vehicle 100 (e.g., environment 202). The microphones 500 are at a plurality of locations in the cabin 110 of the vehicle 100. For example, as shown in FIG. 5, the microphones 500 may be disposed in the dashboard 140, rear deck 150, and/or consoles 160. While the cabin 110 is described and shown to include six microphones 500 at six locations, one of ordinary skill in the art would understand and appreciate that any quantity of any type of sensor unit 210 (shown in FIG. 2) may be in any arrangement that enables the vehicle 100, conversation recognition system 200 (shown in FIG. 2) and/or linguistic system 300 (shown in FIG. 3) to function as described herein.

A sound 216 associated with an utterance 248, for example, may be perceived by the microphones 500 at one or more perceived parameters. The perceived parameters may be compared with each other to identify one or more differences in the perceived parameters, and the differences may be analyzed in light of microphone data (e.g., position data, orientation data, sensitivity data) to identify one or more linguistic features 332, such as an utterance time, an utterance location 502, and/or an utterance direction 504. A microphone 500 associated with an earlier perceived time, a higher perceived volume, and/or a broader perceived sound spectrum, for example, may be closer in space to a source of the sound 216 than another microphone 500. Example parameters include, without limitation, a time, a volume, a sound spectrum, and a direct/reflection ratio.

The utterance location 502 and utterance direction 504 may be analyzed to identify a listening zone 506 associated with the utterance 248. In some examples, the conversation recognition system 200 compares a listening zone 506 associated with one utterance 248 with a listening zone 506 associated with one or more other utterances 248 to identify a difference in the listening zones 506, and compares the difference with one or more predetermined thresholds 334 to determine a likelihood of the utterances 248 being in a common conversation 204. The utterances 248 may then be grouped together or separated from each other based on the determined likelihood. For example, utterances 248 associated with listening zones 506 having a greater amount of overlap may be more likely to be grouped together than utterances 248 associated with listening zones 506 having a lesser amount of overlap. In this manner, utterances 248 associated with listening zones 506 with no overlap may not be grouped together into a common conversation thread 410.

In some examples, the conversation recognition system 200 identifies the occupants 112 and one or more roles associated with the occupants 112. An occupant 112 may be identified, for example, as a speaker 508 of an utterance 248 if the occupant 112 is at or proximate an utterance location 502 or as an intended listener 510 of an utterance 248 if the occupant 112 is in the listening zone 506. In some examples, the conversation recognition system 200 identifies one or more locations of the occupants 112, and compares the locations with a listening zone 506 to identify one or more occupants 112 in the listening zone 506 as potential intended listeners 510. The intended listeners 510 may be identified from the potential intended listeners 510 using, for example, one or more linguistic features 332 other than the utterance location 502, utterance direction 504, and/or listening zone 506. Profile data 258 may also be used to identify one or more occupants 112 and/or their roles.

In some examples, the vehicle 100 includes an optic sensor component 218 (shown in FIG. 2) and/or device sensor component 222 (shown in FIG. 2) that enables one or more visual features 242 associated with light 220 and/or device features 246 associated with one or more user devices 226, respectively, to be identified for identifying or confirming at least some speakers 508 and/or intended listeners 510 and their utterances 248, conversation threads 410, and/or conversations 204. For example, a voiceprint 252, faceprint 254, and/or device identifier 256 may be used to identify one or more occupants 112 (e.g., speaker 508, intended listener 510). Moreover, a shape or movement of the mouth or lips may be indicative of an utterance 248 (e.g., sound 216) and utterance time, a body presence or position and/or a device presence or position may be indicative of an utterance location 502, and/or a body orientation may be indicative of an utterance direction 504.

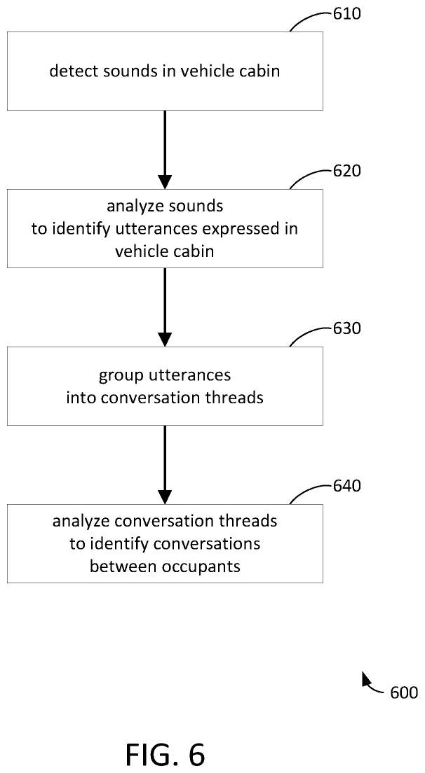

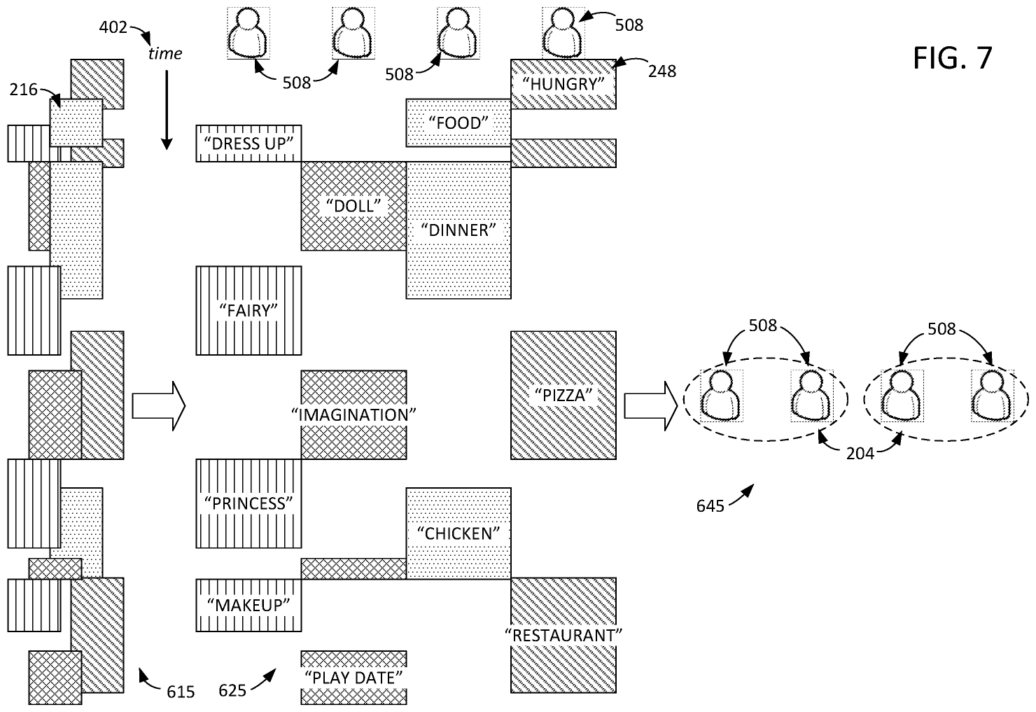

FIG. 6 shows an example method 600 of recognizing conversations 204 in an environment 202 (e.g., cabin 110) using the conversation recognition system 200 (shown in FIG. 2). FIG. 7 conceptually shows various stages of recognizing conversations 204 using the method 600.

A plurality of sounds 216 in the environment 202 are detected at operation 610. As shown in FIG. 7 at a first stage 615, numerous layers of various sounds 216 may be detected over time 402. The sounds 216 may be detected using an acoustic sensor component 214 including, for example, a plurality of microphones 500 (shown in FIG. 5) at one or more locations in the environment 202. In some examples, a time, source, and direction of the sound 216 (e.g., utterance time, utterance location 502, and utterance direction 504, respectively) are identified or confirmed based on differences in parameters perceived by the microphones 500 in light of microphone data (e.g., position data, orientation data, sensitivity data).

The sounds 216 are analyzed at operation 620. In some examples, one or more signals 212 are funneled to a speech recognition unit 230 for processing. The signals 212 may be processed, for example, to identify one or more auditory features 238, visual features 242, device features 246. In some examples, the signals 212 are processed to distinguish speech from noise, identify a plurality of speaker change points in the speech, and identify a plurality of utterances 248 expressed in the environment 202 using the speaker change points. As shown in FIG. 7 at a second stage 625, the utterances 248 may be grouped by speaker 508. In some examples, the signals 212 are processed to identify a presence of a plurality of users 206 (e.g., occupants 112) in the environment 202, identify one or more users 206 as speakers 508, and associate the utterances 248 with the speakers 508.

The utterances 248 are grouped into a plurality of conversation threads 410 (shown in FIG. 4) at operation 630. The utterances 248 may be grouped, for example, based on the content of the utterances 248 and one or more content-agnostic factors, such as a speaker identity, a speaker location, a listener identity, a listener location, and/or an utterance time. The conversation threads 410 are analyzed at operation 640 to identify a plurality of conversations 204 between a plurality of users 206. That is, rather than identify a single conversation 204 common to all the users 206 in the environment 202, as shown in FIG. 7 at a third stage 645, one conversation 204 about a play date among one set of speakers 508 may be distinguished from another conversation 204 about dinner among another set of speakers 508. In some examples, the conversation threads 410 are grouped based on the content of the conversation threads 410 (e.g., utterances 248) and one or more content-agnostic factors to facilitate distinguishing between multiple conversations 204.

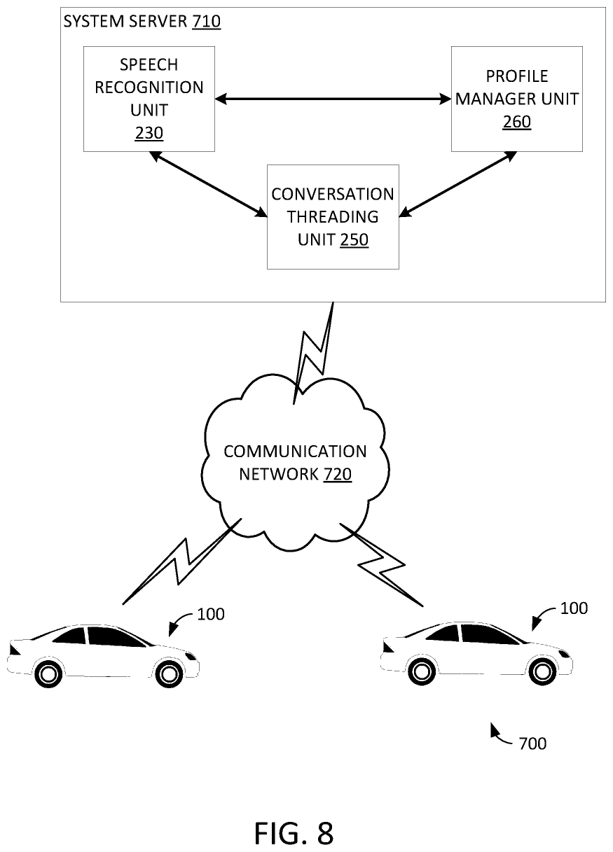

FIG. 8 shows an example cloud-based environment 700 including a plurality of vehicles 100. The vehicles 100 may include one or more sensor units 210 (shown in FIG. 2) that detect one or more stimuli in a cabin 110 (shown in FIG. 1) of the vehicles 100, and generate one or more signals 212 associated with the stimuli. The vehicles 100 include one or more client-side applications that perform one or more operations at the vehicles 100 while one or more operations are performed remotely. For example, the client-side applications may allow the vehicles 100 to communicate with one or more computing systems (e.g., the “cloud”) that perform one or more back-end operations using one or more counterpart applications (e.g., server-side applications) and/or through one or more server-side services. In some examples, the vehicles 100 transmit the signals 212 to a system server 710 for back-end processing.

The system server 710 provides a shared pool of configurable computing resources to perform one or more backend operations. The system server 710 may host or manage one or more server-side applications that include or are associated with speech recognition technology and/or natural language understanding technology, such as a speech-to-text application configured to disassemble and parse natural language into transcription data and prosody data. In some examples, the system server 710 includes a speech recognition unit 230, a conversation threading unit 250, and a profile manager unit 260.

The cloud-based environment 700 includes one or more communication networks 720 that allow information to be communicated between a plurality of computing systems coupled to the communication networks 720 (e.g., vehicle 100, speech recognition unit 230, conversation threading unit 250, profile manager unit 260, system server 710). Example communication networks 720 include, without limitation, a cellular network, the Internet, a personal area network (PAN), a local area network (LAN), and a wide area network (WAN). In some examples, the system server 710 includes, is included in, or is coupled to one or more artificial neural networks that “learn” and/or evolve based on information or insights gained through the processing of one or more signals 212, features (e.g., auditory features 238, visual features 242, device features 246, verbal features 312, nonverbal features 314), speech-oriented aspects (e.g., conversations 204, utterances 248, candidate words 322, thresholds 334, conversation threads 410), and/or profile data 358 (e.g., voiceprints 252, faceprints 254, device identifiers 256).

One or more interfaces (not shown) may facilitate communication within the cloud-based environment 700. The interfaces may include one or more gateways that allow the vehicle 100, speech recognition unit 230, conversation threading unit 250, and/or profile manager unit 260 to communicate with each other and/or with one or more other computing systems for performing one or more operations. For example, the gateways may format data and/or control one or more data exchanges using an Open Systems Interconnection (OSI) model that enables the computing systems (e.g., vehicle 100, speech recognition unit 230, conversation threading unit 250, profile manager unit 260, system server 710) to communicate using one or more communication protocols. In some examples, the gateways identify and/or locate one or more target computing systems to selectively route data in and/or through the cloud-based environment 700.

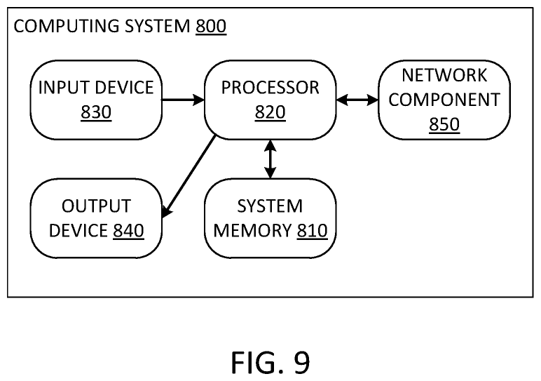

FIG. 9 shows an example computing system 800 configured to perform one or more computing operations. While some examples of the disclosure are illustrated and described herein with reference to the computing system 800 being included in a conversation recognition system 200 (shown in FIG. 2) and/or a linguistic system 300 (shown in FIG. 3), aspects of the disclosure are operable with any computing system (e.g., vehicle 100, sensor unit 210, acoustic sensor component 214, optic sensor component 218, device sensor component 222, user device 226, speech recognition unit 230, filter 232, decoder 234, voice recognition component 236, facial recognition component 240, device recognition component 244, conversation threading unit 250, profile manager unit 260, acoustic model 310, lexicon 320, language model 330, microphone 500, system server 710) that executes instructions to implement the operations and functionality associated with the computing system 800. The computing system 800 shows only one example of a computing environment for performing one or more computing operations and is not intended to suggest any limitation as to the scope of use or functionality of the disclosure.

In some examples, the computing system 800 includes a system memory 810 (e.g., computer storage media) and a processor 820 coupled to the system memory 810. The processor 820 may include one or more processing units (e.g., in a multi-core configuration). Although the processor 820 is shown separate from the system memory 810, examples of the disclosure contemplate that the system memory 810 may be onboard the processor 820, such as in some embedded systems.

The system memory 810 stores data associated with one or more users and/or vehicles 100 and computer-executable instructions, and the processor 820 is programmed or configured to execute the computer-executable instructions for implementing aspects of the disclosure using, for example, the conversation recognition system 200, and/or linguistic system 300. For example, at least some data may be associated with one or more vehicles 100 (e.g., VIN), users 206 (e.g., profile data 258), user devices 226 (e.g., device identifier 256), sensor units 210, speech recognition units 230, conversation threading units 250, acoustic models 310, lexicons 320, language models 330, and/or thresholds 334 such that the computer-executable instructions enable the processor 820 to manage or control one or more operations of a vehicle 100, conversation recognition system 200, and/or linguistic system 300.

The system memory 810 includes one or more computer-readable media that allow information, such as the computer-executable instructions and other data, to be stored and/or retrieved by the processor 820. In some examples, the processor 820 executes the computer-executable instructions to identify a plurality of sounds 216 in the cabin 110 of a vehicle 100, analyze the sounds 216 to identify a plurality of utterances 248 expressed in the cabin 110 of the vehicle 100, group the utterances 248 to form a plurality of conversation threads 410 based on content and one or more content-agnostic factors (e.g., content-agnostic linguistic features 332), and group the conversation threads 410 to form a plurality of conversations 204 between a plurality of occupants 112 of the vehicle 100.

By way of example, and not limitation, computer-readable media may include computer storage media and communication media. Computer storage media are tangible and mutually exclusive to communication media. For example, the system memory 810 may include computer storage media in the form of volatile and/or nonvolatile memory, such as read only memory (ROM) or random access memory (RAM), electrically erasable programmable read-only memory (EEPROM), solid-state storage (SSS), flash memory, a hard disk, a floppy disk, a compact disc (CD), a digital versatile disc (DVD), magnetic tape, or any other medium that may be used to store desired information that may be accessed by the processor 820. Computer storage media are implemented in hardware and exclude carrier waves and propagated signals. That is, computer storage media for purposes of this disclosure are not signals per se.

A user or operator (e.g., user 206) may enter commands and other input into the computing system 800 through one or more input devices 830 (e.g., vehicle 100, sensor units 210, user device 226) coupled to the processor 820. The input devices 830 are configured to receive information (e.g., from the user 206). Example input device 830 include, without limitation, a pointing device (e.g., mouse, trackball, touch pad, joystick), a keyboard, a game pad, a controller, a microphone, a camera, a gyroscope, an accelerometer, a position detector, and an electronic digitizer (e.g., on a touchscreen). Information, such as text, images, video, audio, and the like, may be presented to a user via one or more output devices 840 coupled to the processor 820. The output devices 840 are configured to convey information (e.g., to the user 206). Example, output devices 840 include, without limitation, a monitor, a projector, a printer, a speaker, a vibrating component. In some examples, an output device 840 is integrated with an input device 830 (e.g., a capacitive touch-screen panel, a controller including a vibrating component).

One or more network components 850 may be used to operate the computing system 800 in a networked environment using one or more logical connections. Logical connections include, for example, local area networks, wide area networks, and the Internet. The network components 850 allow the processor 820, for example, to convey information to and/or receive information from one or more remote devices, such as another computing system or one or more remote computer storage media. Network components 850 may include a network adapter, such as a wired or wireless network adapter or a wireless data transceiver.

Example voice and conversation recognition systems are described herein and illustrated in the accompanying drawings. For example, an automated voice and conversation recognition system described herein is configured to distinguish speech from noise and distinguish one conversation from another conversation. The examples described herein are able to identify and discern between concurrent conversations without a priori knowledge of the content of the conversations, the identity of the speakers, and/or the number of conversations and/or speakers. Moreover, the examples described herein identify conversations and/or speakers in a dynamic manner For example, the profile manager and/or artificial neural network enable the examples described herein to evolve based on information or insight gained over time, resulting in increased speed and accuracy. This written description uses examples to disclose aspects of the disclosure and also to enable a person skilled in the art to practice the aspects, including making or using the above-described systems and executing or performing the above-described methods.

Having described aspects of the disclosure in terms of various examples with their associated operations, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense. For example, the examples described herein may be implemented and utilized in connection with many other applications such as, but not limited to, safety equipment.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a drawing may be referenced and/or claimed in combination with any feature of any other drawing.

When introducing elements of the disclosure or the examples thereof, the articles “a,” “an,” “the,” and “said” are intended to mean that there are one or more of the elements. References to an “embodiment” or an “example” of the present disclosure are not intended to be interpreted as excluding the existence of additional embodiments or examples that also incorporate the recited features. The terms “comprising,” “including,” and “having” are intended to be inclusive and mean that there may be elements other than the listed elements. The phrase “one or more of the following: A, B, and C” means “at least one of A and/or at least one of B and/or at least one of C.”

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An on-board conversation recognition system comprising:
an acoustic sensor component configured to detect sound in a cabin of a vehicle;
a voice recognition component coupled to the acoustic sensor component, the voice recognition component configured to analyze the sound detected by the acoustic sensor component and identify a plurality of utterances; and
a conversation threading unit coupled to the voice recognition component, the conversation threading unit configured to analyze the plurality of utterances identified by the voice recognition component and identify a plurality of conversations between a plurality of occupants of the vehicle.

2. The on-board conversation recognition system of claim 1, wherein the acoustic sensor component includes a plurality of microphones at one or more locations in the cabin of the vehicle, the voice recognition component determining one or more locations of one or more of the plurality of occupants based at least in part on the one or more locations of the plurality of microphones.

3. The on-board conversation recognition system of claim 1, wherein the voice recognition component analyzes the plurality of utterances to identify one or more voiceprints, compares the identified one or more voiceprints with one or more familiar voiceprints, and identifies one or more of the plurality of occupants based at least in part on the comparison.

4. The on-board conversation recognition system of claim 1 further comprising:
an optic sensor component configured to detect light in the cabin of the vehicle; and
a facial recognition component coupled to the optic sensor component, the facial recognition component configured to analyze the light detected by the optic sensor component, identify one or more images, analyzes the one or more images to identify one or more faceprints, compares the identified one or more faceprints with one or more familiar faceprints, and identifies one or more of the plurality of occupants based at least in part on the comparison.

5. The on-board conversation recognition system of claim 1 further comprising:
a device sensor component configured to detect one or more devices in the cabin of the vehicle; and
a device recognition component coupled to the device sensor component, the device recognition component configured to receive one or more identifiers associated with the one or more devices detected by the device sensor component, compares the received one or more identifiers with one or more familiar identifiers, and identifies one or more of the plurality of occupants based at least in part on the comparison.

6. The on-board conversation recognition system of claim 1, wherein the voice recognition component compares the plurality of utterances with profile data associated with one or more users, and identifies one or more of the plurality of occupants based at least in part on the comparison.

7. The on-board conversation recognition system of claim 1 further comprising a profile manager unit configured to maintain profile data associated with one or more users, the profile data including two or more of a user identifier, biometric data, a vehicle identifier, a device identifier, user preference data, or activity history data.

8. The on-board conversation recognition system of claim 1, wherein the conversation threading unit analyzes the plurality of utterances to identify one or more keywords, analyzes the identified one or more keywords to identify one or more topics associated with the plurality of utterances, and groups the plurality of utterances in one or more conversation threads based at least in part on the identified one or more topics.

9. The on-board conversation recognition system of claim 1, wherein the conversation threading unit analyzes the plurality of utterances to identify one or more discourse markers, and groups the plurality of utterances in one or more conversation threads based at least in part on the identified one or more discourse markers.

10. The on-board conversation recognition system of claim 1, wherein the conversation threading unit analyzes the plurality of utterances to identify a plurality of utterance times, and groups the plurality of utterances in one or more conversation threads based at least in part on the identified plurality of utterance times.

11. The on-board conversation recognition system of claim 1, wherein the conversation threading unit analyzes the plurality of utterances to identify one or more listening zones, and groups the plurality of utterances in one or more conversation threads based at least in part on the identified one or more listening zones.

12. The on-board conversation recognition system of claim 1, wherein the conversation threading unit identifies one or more roles associated with the plurality of occupants of the vehicle, and groups the plurality of utterances in one or more conversation threads based at least in part on the identified one or more roles.

13. A method for recognizing conversation in a cabin of a vehicle, the method comprising:
detecting a plurality of sounds in the cabin of the vehicle;
analyzing the plurality of sounds to identify a plurality of utterances expressed in the cabin of the vehicle;
grouping the plurality of utterances into one or more conversation threads based on content of the plurality of utterances and one or more content-agnostic factors, the one or more content-agnostic factors including a speaker identity, a speaker location, a listener identity, a listener location, and an utterance time; and
analyzing the one or more conversation threads to identify a plurality of conversations between a plurality of occupants of the vehicle.

14. The method of claim 13 further comprising:
analyzing the plurality of utterances to identify one or more keywords; and
identifying one or more topics associated with the plurality of utterances, the one or more topics corresponding to the identified one or more keywords, the plurality of utterances grouped based at least in part on the identified one or more topics.

15. The method of claim 13 further comprising analyzing the plurality of utterances to identify one or more discourse markers, the plurality of utterances grouped based at least in part on the identified one or more discourse markers.

16. The method of claim 13 further comprising analyzing the plurality of utterances to identify a linking utterance common to a plurality of adjacency pairs, the plurality of utterances grouped based at least in part on the identified linking utterance.

17. The method of claim 13 further comprising analyzing the plurality of utterances to identify a plurality of utterance times including the utterance time, the plurality of utterances grouped based at least in part on the identified plurality of utterance times.

18. The method of claim 13 further comprising analyzing the plurality of utterances to identify one or more listening zones including the speaker location and the listener location, the plurality of utterances grouped based at least in part on the identified one or more listening zones.

19. The method of claim 13 further comprising:
identifying one or more of the plurality of occupants using one or more of a voiceprint, a faceprint, or a device identifier; and
determining one or more locations of the one or more of the plurality of occupants.

20. A computing system for use in recognizing conversation in a cabin of a vehicle, the computing system comprising:
one or more computer storage media including data associated with one or more vehicles and computer-executable instructions; and
one or more processors configured to execute the computer-executable instructions to:
identify a plurality of sounds in the cabin of a first vehicle of the one or more vehicles;
analyze the plurality of sounds to identify a plurality of utterances expressed in the cabin of the first vehicle;
group the plurality of utterances to form a plurality of conversation threads based on content and one or more content-agnostic factors, the one or more content-agnostic factors including a speaker identity, a speaker location, a listener identity, a listener location, and an utterance time; and
group the plurality of conversation threads to form a plurality of conversations between a plurality of occupants of the first vehicle.
